(19) United States
(12) Patent Application Publication
(10) Pub. No.: US 2017/0122392 A1
(43) Pub. Date: May 4, 2017

(54) Brake Disc for a Motor Vehicle

(71) Applicant: Daimler AG, Stuttgart (DE)

(72) Inventor: Oliver LEMBACH, Deckenpfronn (DE)

(73) Assignee: Daimler AG, Stuttgart (DE)

(21) Appl. No.: 15/318,636

(22) PCT Filed: May 23, 2015
(86) PCT No.: PCT/EP2015/001064

§ 371 Date: Dec. 13, 2016

(30) Foreign Application Priority Data
Jun. 14, 2014 (DE) 10 2014 008 844.8

(51) Int. Cl. F16D 65/12; F16D 69/04; C25D 11/02; C23C 8/80; C23C 8/22; C23C 8/10; C23C 8/46; C23C 8/50; F16D 69/02; C23C 8/26

(52) U.S. Cl. CPC F16D 65/127; F16D 65/125; F16D 69/027; F16D 69/04; C25D 11/02; C23C 8/26; C23C 8/22; C23C 8/10; C23C 8/46; C23C 8/50; C23C 8/80; F16D 2065/132

(57) ABSTRACT

A brake disc for a motor vehicle is disclosed. The brake disc includes a substrate, in particular a grey cast iron substrate, at least one friction surface formed on the substrate and at least one cover layer applied at least to the at least one friction surface. The cover layer is harder and thinner than the substrate and color changes to enable identification are introduced in the cover layer by a pulsed laser.

### BACKGROUND AND SUMMARY OF THE INVENTION

The invention relates to a brake disc for a motor vehicle, comprising a substrate, in particular a grey cast iron substrate, at least one friction surface formed on the substrate, and at least one cover layer applied at least to the at least one friction surface. Moreover, the invention relates to a method for the production of such a brake disc.

Brake discs have friction surfaces which form a tribological system with the brake pads. When braking, if the stationary brake pads are brought into contact with the rotating friction surfaces, the friction surfaces of the brake discs heat up as a result of the friction. The braking action depends on the state and the surface finish of the friction surface. Precisely the increased temperature of the brake disc as a result of the braking process, where applicable in conjunction with corrosive media, such as water and gritting salt, leads to or accelerates the corrosion that occurs on the friction surfaces. For this reason, brake discs are often provided with a corrosion protection layer on the friction surfaces. If this nevertheless has cracks, for example as a result of different coefficients of thermal expansion, which extend as far as the base plate of the brake disc, or if cover layer and base plate have different electrochemical voltage potentials, corrosion of the base plate can occur under the cover layer (corrosive infiltration), which leads to a delamination of the coated base plate and thus to limitations, culminating in a loss of the braking action.

In order to improve the resistance to corrosion and oxidation of the brake pads, above all also at higher temperatures, the friction surfaces of brake discs made of iron-based material are provided with a corrosion protection layer, by undergoing a nitrocarburizing surface treatment and subsequent oxidative after-treatment.

At the same time, for functional or optical reasons, it is desirable to introduce recesses into the friction surfaces, such as holes (perforated brake discs) or slits. Such recesses would nevertheless pierce through the cover layer, whereby corrosion of the base plate can again occur. Even if the cover layer were to be applied after introducing the recesses, a greater risk of corrosion on the edges around the recesses would exist.

A method for nitrocarburizing brake rotors of a motor vehicle is known from DE 10 2007 027 933 B4. The brake rotor made of an iron-based material is warmed and treated in a tempered, ferritic, nitrocarburizing salt bath and a tempered, oxidizing salt bath. Afterwards, the surface of the brake rotor has a connection layer and a diffusion layer below that. On the surface of the connection layer there is an oxide coating containing Fe₃O₄, including the connection layer consisting chiefly of ε iron nitride, Fe₃N, as well as a small amount of γ′ iron nitride, Fe₄N. The diffusion layer contains a concentration of diffused nitrogen in the iron-based material, the concentration being lower than in the compound layer.

DE 10 2011 053 253 A1 describes a brake disc made of a support component and a friction ring, which are connected to each other by connection elements made of steel material. Thus the connection elements have a corrosion protection layer, at least on the end sections, this layer consisting, in an appropriate manner, of a diffusion layer, a connection layer on top of that containing iron carbon nitride, and an oxide layer on top of that.

DE 195 25 182 A1 discloses a gas method for producing corrosion and wear protection layers on iron-based materials, the method avoiding the disadvantages of salt bath methods in relation to environmental pollution, and the surface topography produced - the surfaces produced by the salt bath method are rough and require a finishing process. Thus, the nitrocarburization is initially carried out by a standard-pressure gas method, wherein the connection layer is formed of iron carbon nitrides, whereupon the surface of the connection layer is activated by a plasma-assisted low-pressure method, before a sealed and even oxide layer is formed by oxidation in the standard-pressure gas method.

The described method for producing a corrosion and wear protection layer on low-alloyed steels is known by the name IONIT OX™ by Sulzer Metco, Bergisch Gladbach (http://www.sulzer.com).

A method for producing a grey cast iron brake disc for a vehicle is described in EP 2 394 072 B1, the friction surfaces of this brake disc being after-treated by carburizing, carbon-nitriding, case hardening, gas-nitriding, oxide-nitriding, gas-nitrocarburizing, plasma-nitriding, plasma-oxidizing, boriding, plasma-carburizing or plasma-boriding. Before the after-treatment, the friction surfaces can be provided with a coating made of tungsten carbide, chromium carbide and nickel, or made of tungsten carbide, cobalt, chromium and nickel.

A coated component, or brake disc, is also known from DE 10 2011 122 308 A1, wherein an intermediate layer between substrate and cover layer is formed by phosphating, nitriding, boriding, sputtering, austempering, carburizing, plasma-nitrocarburizing, anodizing, by a chemical nickel dispersion, by a thermal method, by a chemical method, by physical vapor deposition, and/or by chemical vapor disposition.

DE 10 2004 016 092 A1 discloses a brake disc having a base plate and a coating with at least one wear resistant layer, which serves as a friction layer. The thickness of at least one layer of the coating and/or the thickness of the coating is a maximum of around 150 μm.

A method for providing a brake disc with an identification on the friction surfaces of the brake discs is known from DE 10 2012 221 365 A1. In order to achieve an abrasion-proof identification, a chemical or physical treatment of the brake disc is conducted by a template in the shape of the identification. Thus the brake disc has an area in the shape of the identification that has different properties from the rest of the brake disc, such as a different hardness.

A brake disc having radial grooves on the friction surfaces, these grooves being formed in the shape of an arc and being open towards an outer side of the brake disc in a radial direction, is known from DE 698 11 661 T2.

DE 10 2011 075 821 A1 discloses a brake disc having a base plate and a wearing surface applied upon this. For implementing the connection between the wearing surface and the base plate, the contact surface of the base plate is pre-treated by laser radiation to modify the surface topography,

A friction disc having a wear protection layer and an integrated wear indicator is described in DE 10 2010 013 343 A1. At least one indication surface element is provided between the wear protection layer and the friction disc, this element occupying a part of the friction surface and differing from the friction surface and the wear protection layer by at least one of the features coloring and structure. The indication surface element is released by the removal of the wear protection layer.

The object of the present invention is to provide a brake disc with a visual identification, the brake disc being nevertheless protected against corrosion and wear.

The invention is based on the general idea of introducing visual identifications on the cover layer, rather than notches that pierce through the brake disc. In this way, the corrosion protection effect of the cover layer is retained. Expediently, the cover layer is harder and thinner than the substrate, wherein color changes are introduced on the cover layer. It is therefore essential that the substrate also be covered by the cover layer where the color changes are located. Thus, the cover layer is preferably a wear protection layer or corrosion protection layer and the substrate is a brake disc body made of grey cast iron. Color changes can be introduced in order to enable an identification of the brake pad, for example by a label, type number or serial number.

A favorable option provides that the color changes and, where applicable, dents are introduced into the cover layer by means of a pulsed laser. Very precise material processing can be carried out by a pulsed laser, such that it is possible to introduce the color changes and where applicable the dents within only the cover layer. Chemical reactions or fusing processes, for example, can be triggered by the energy of the pulsed laser, which result in in a color change, for example in a darkening, lightening or a metallic sheen.

A further favorable option provides that the cover layer has a microhardness of more than 300 HV.03, more favorably, more than 500 HV.03, or most favorably more than 800 HV.03. The wear of the cover layer decreases as a result of the high hardness of the cover layer, such that the lifespan is increased.

A particularly favorable option provides that the cover layer has ceramic, for example, silicon carbide reinforced with carbon fiber (C/SiC) and/or an aluminum alloy reinforced with silicon carbide (Al-SiC). A higher hardness of the cover layer is achieved by the use of ceramic in the cover layer, which in turn extends the lifespan of the brake disc.

A further particularly favorable option provides that the cover layer has a thickness of less than 1000 μm, in particular that it has a thickness of between 100 and 500 μm. The costs for the cover layer can be reduced by a small thickness of the cover layer. In addition, the mechanical properties of the brake disc are thus more greatly influenced by the substrate, which is more cost-effective and offers a high level of mechanical stability.

An advantageous solution provides that at least one surface layer is formed between the substrate and the cover layer, which comprise layers containing nitrides, carbides and/or oxides, therefore formed by nitriding, carburizing, nitrocarburizing and/or oxidizing. In order to improve the corrosion and crack resistance, as well as the wear protection, the cover layer consists of a cermet material, made of a metallic matrix and a ceramic component distributed in it that makes up 30 to 70% b. w. of the cermet material.

“Cermet” denotes very hard and wear resistant composite materials made of ceramic materials in a metallic matrix, having high thermo-shock and oxidation consistency.

The cermet cover layer, in connection with the hardened surface layer formed by nitriding, carburizing, nitrocarburizing and/or oxidizing, forming an electrochemical barrier, gives the component clearly improved corrosion and crack resistance. Thus, a corrosive infiltration resulting in the complete breakdown of the layer system can clearly be delayed by delamination and thus the durability and lifespan of the layer system, or the component—for instance the brake disc in the vehicle—can clearly be extended.

A further advantageous solution provides that the metallic matrix is a high alloy CrNiMo steel, which preferably has a composition comprising 28% b.w. chromium, 16% b.w. nickel, 4.5% b. w. molybdenum, 1.5% b.w. silicon, 1.75% b. w. carbon, and the rest iron.

A particularly advantageous solution provides that the metallic matrix is an NiCrMo alloy, which preferably has a composition comprising 20 to 23% b. w. chromium, up to 5% b. w. iron, 8 to 10% b. w. molybdenum, 3.15 to 4.15% b. w. niobium and tantalum in total, and the rest nickel, particularly preferably a composition comprising 21.5% b. w. chromium, 2.5% b. w. iron, 9.0% b. w. molybdenum, 3.7% b. w. niobium and tantalum in total, and the rest nickel.

A further particularly advantageous solution provides that the ceramic components comprise oxide ceramics, which are chosen from Al₂O₃, TiO₂, ZrO₂ and MgAl₂O₄ and combinations of these.

An advantageous option provides that the ceramic component comprises Al₂O₃ and at least one further oxide ceramic, chosen from the group comprising TiO₂, ZrO₂, MgAl₂O₄, wherein Al₂O₃ makes up a proportion of 60 to 90% b. w. of the total ceramic components.

A further advantageous option provides that the surface layer, starting from the substrate, has a diffusion layer, a nitride and carbide containing connecting layer and an oxide layer, wherein the diffusion layer has a thickness of 0.1 to 0.8 mm, the connecting layer a thickness of 2 to 30 μm and the oxide layer a thickness of 1 to 5 μm.

The connecting layer preferably contains predominantly ε iron nitride, as well as other nitrides and carbides. The oxide layer preferably contains predominantly iron oxide.

A particularly advantageous option provides that an intermediate layer is provided between the cover layer and the surface layer, this intermediate layer consisting of a nickel-based alloy, preferably a nickel chromium alloy, or of a metallic matrix, wherein the intermediate layer made of the nickel-based alloy or the matrix metal has a thickness of 30 to 120 μm.

In order to improve the connection of the cover layer to the substrate, the surface layer of the substrate, and thus the surface or intermediate layers in the areas covered by the cover layer, can be mechanically roughened or profiled, such that the cover layer interlocks with the substrate.

Moreover, according to the invention, the aforementioned object is solved by a method for the production of a brake disc according to the present description, which comprises production of a brake disc blank, formation of the cover layer, at least on the friction surfaces of the brake disc, and introduction of the color changes into the cover layer by means of a pulsed laser.

In this way, a brake disc having a corrosion and wear protecting cover layer is obtained.

A favorable solution provides a nitriding, carburizing, nitrocarburizing in a gas, plasma or salt bath process and/or oxidizing by anodic or plasma-oxidation, preferably nitrocarburizing, plasma activating and oxidizing, of the substrate, at least on the friction surfaces before the forming of the cover layer, thereby forming the surface layer, providing a cermet material made of a metallic matrix and a ceramic component distributed in it, which makes up 30 to 70% b. w., and thereupon forming the cover layer by applying the cermet material to the surface layer.

The application of the cermet material can be carried out by thermal spraying.

A particularly favorable solution provides that, before the nitiriding, carburizing, nitrocarburizing and/or oxidizing, the surfaces of the substrate, at least on the friction surfaces, are mechanically roughened or profiled.

Alternatively or additionally, for the profiling of the substrate surface layer, a nickel based alloy or the pure matrix metal on the surface layer can be applied after the nitriding, carburizing, nitrocarburising and/or oxidizing of the substrate surface layer, and thus an additional intermediate layer can be formed as wear protection and where applicable for supporting the adhesion of the cover layer to the surface layer.

The application of the nickel based alloy or the matrix metal can also be carried out by thermal spraying.

Further important features and advantages of the invention result from the sub-claims, the drawings and the corresponding description of the figures by means of the drawings.

It is understood that the features that are named above and are still to be illustrated below are not only able to be used in the respectively specified combination, but also in other combinations or individually, without exceeding the scope of the present invention.

Preferred exemplary embodiments of the invention are depicted in the drawings and illustrated in greater detail in the description below, wherein the same reference numerals refer to the same or similar or functionally identical components.

Here, schematic views of the following are depicted.

### BRIEF DESCRIPTION OF THE DRAWINGS

FIG. 1 is an overview of the brake disc according to the invention having several dents,

FIG. 2 is a sectional depiction of a section of the brake disc, in the area of a dent, along the line AA in FIG. 1,

FIG. 3 is a sectional depiction of a section of the brake disc, in the area of a dent having an alternative shape of the dent, along the line AA in FIG. 1,

FIG. 4 is a cross-sectional view through a section of a brake disc according to the invention without dents, having a hardened surface layer, a further nickel based intermediate layer and a cover layer,

FIG. 5 is a cross-sectional view through a section of a brake disc according to the invention having the surface layer formed of diffusion layer, connecting layer and oxide layer, a further nickel based intermediate layer and a cover layer, and

FIG. 6 is a microscopic image of the microsection through a section of the brake disc according to the invention having a profiled surface and a hardened surface layer, a further nickel based intermediate layer and a cover layer.

### DETAILED DESCRIPTION OF THE DRAWINGS

The invention relates to a brake disc 1 having a substrate 2, in particular having a grey cast iron substrate, whose corrosion and wear properties are improved by a hardened surface layer 3 and a cover layer applied on top of it 4, where applicable more layers as well, wherein color changes 9 and, if applicable, dents 6, which do not pierce through the cover layer, are introduced in the cover layer. The layers prevent or reduce the broadening of tears, for example, that could appear on the surface during the service of the brake disc 1. Due to the fact that the spreading of tears into the substrate 2 is prevented, a corrosive infiltration of the layers is also effectively prevented, such that failure of the brake disc 1, for example through delamination, does not occur, or only occurs much later. The dents 6 can be designed to clean the brake pad or be formed as wear markings, for example.

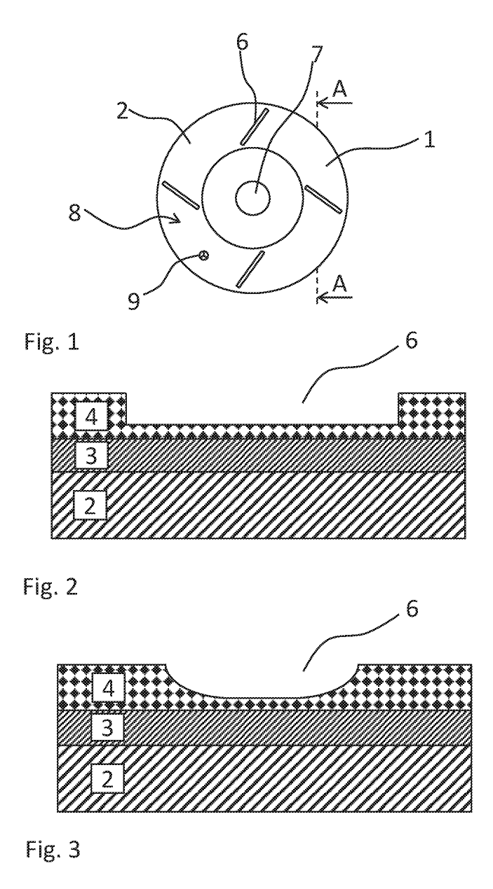

A brake disc 1 presented in FIG. 1 has a hub 7 and at least one, for example two, friction surfaces 8, which are arranged coaxially to the hub. When braking, brake pads are applied to the friction surfaces. The friction surfaces 8 each have the surface layer 3 and the cover layer 4 applied on top of them. In every cover layer, several, for example four, dents are introduced.

In order to not destroy the corrosion protection effect of the cover layer 4, the dents 6 are only introduced in the cover layer 4, meaning they do not pierce through the cover layer 4. The remaining thickness of the cover layer 4 under the dents 6 should be large enough to avoid any further crack formation in the cover layer 4.

The dents 6 can be introduced into the cover layer 4 by means of a pulsed laser. With the pulsed laser the cover layer 4 can be treated without exerting large amounts of force on the cover layer 4. In this way, damages to the cover layer 4, even with small thicknesses of the cover layer 4, can be avoided.

Additionally, the pulsed laser enables the dents 6 to be formed virtually at random. For example, steep edges or smooth transitions between the surface and the dent 6 are possible.

Moreover, a color change 9 of the surface can also be made possible by means of the pulsed laser. In this way, serial numbers, type numbers or trademarks, for example, can be applied to the friction surfaces 8 of the brake disc 1. Likewise, it is possible to use a dent 6 to identify the brake disc 1.

In the following, the embodiment of an exemplary cover layer 4 will be explained, in which color changes 9 according to the invention can be introduced.

On the surface of the substrate 2 which forms the base plate of the brake disc 1, a hardened surface layer 3 is formed by nitriding, carburizing, nitrocarburizing and/or oxidizing, onto which a cover layer 4 is applied. The cover layer 4 consists of a cermet material made of a metallic matrix and a ceramic component distributed in it, the component making up 30 to 70% b. w. of the cermet material.

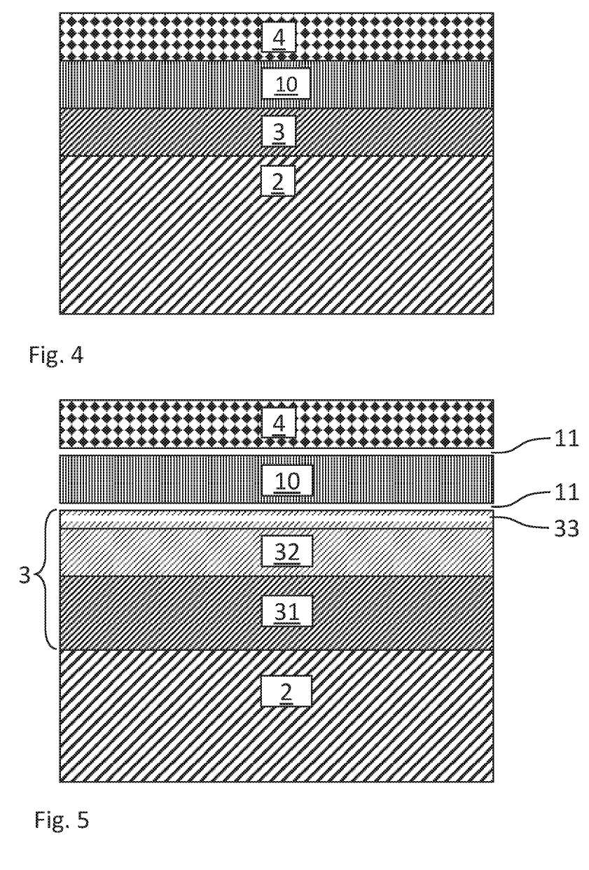

An alternatively designed brake disc, presented in FIG. 4, has an additional intermediate layer 10, made of a nickel based alloy, between the hardened surface layer 3 and the cover layer 4, preferably a corrosion resistant nickel chromium alloy, capable of withstanding high temperatures.

The production of a brake disc 1 according to the invention is explained below by reference to FIG. 5, in which the layers of a brake disc 1 according to the invention are outlined in more detail in an embodiment having an additional intermediate layer 10.

A brake disc according to the invention has the hardened surface layer 3 on the substrate 2, which is a cast brake disc blank, the surface layer 3 being preferably formed by nitriding, plasma-activating and oxidizing, according to the IONIT OX™ method, where applicable also by other nitriding, carburizing, nitrocarburizing and/or oxidization processes. Optionally, the surface of the substrate 2 can be mechanically profiled beforehand. The surface layer 3, starting from the substrate 2, is composed of a diffusion layer 31, a compound layer 32 and an oxide layer 33. During the nitrocarburizing, nitrogen and carbon penetrate the surface of the substrate 2, wherein in the connecting layer 32, whose thickness is in a range from 2 to 30 μm, predominantly ε iron nitride or ε carbon nitride are formed, as well as γ′ iron nitride and other nitrides in smaller quantities. Under the connecting layer 32, the diffusion layer 31 extends into the substrate 2, the diffusion layer having a lower concentration of nitrogen and carbon diffused in than in the connecting layer 32, and the nitrogen is in “solution” in the substrate structure, alongside the other nitrides, carbides and nitride precipitation. The thickness of the diffusion layer 31 ranges from 0.1 to 0.8 mm, also depending on the conditions of treatment and the properties of the substrate.

The surface of the connecting layer 32 is oxidized after plasma activation, such that a largely sealed oxide layer 33 made of Fe₃O₄, with a thickness ranging from 1 to 5 μm, is formed on the connection layer 32, which has a defined pore structure.

In order to obtain the layer construction from FIG. 5, an intermediate layer 10 made of a nickel based alloy or the matrix metal is applied to the oxide layer 33, before the cermet material for forming the cover layer 4 is applied. The intermediate layer 10 can have a thickness ranging from 30 to 120 μm and the cover layer 4 a thickness ranging from 100 to 500 μm.

Between the intermediate layer 10 and the oxide layer 33—in exemplary embodiments without the intermediate layer 10 correspondingly between the cermet cover layer 4 and the oxide layer 33—there is a mixed zone 11, in which the iron oxide of the oxide layer 33 is combined with the nickel based alloy or the matrix metal of the intermediate layer 10 (or with the matrix metal of the cover layer 4). If the intermediate layer 10 consists of a nickel based alloy, which differs from the matrix metal, then there is also a mixed zone 11 between the cover layer 4 and the intermediate layer 10. The thickness of the mixed zone 11 can vary depending on the type of application and parameters of application.

Both the application of the nickel based alloy or the matrix metal for forming the intermediate layer 10, and the application of the cermet material for forming the cover layer 4, can be carried out by thermal spraying.

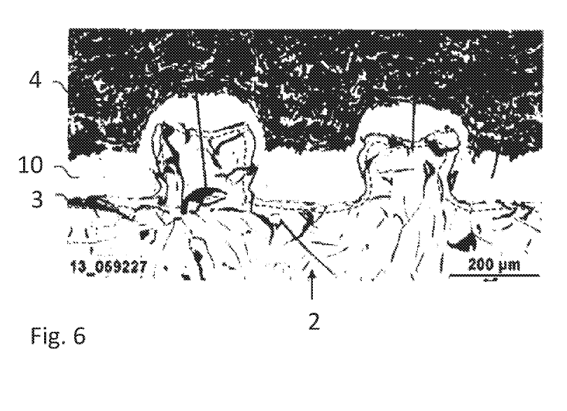

The photographic microscope image in FIG. 6 shows a substrate 2 profiled on the surface. The hardened surface layer 3 is on the surface of the substrate 2 having a thickness of approx. 30 μm of compound layer 32 and 3 μm of oxide layer 33, and is indicated by the dotted line. In this exemplary embodiment, a nickel based intermediate layer 10 with a thickness of on average ca. 100 μm is applied to the profiled substrate 2 or the surface layer 3. As can be seen in the image, the thickness of the intermediate layer 10 varies because of the profiled surface of the substrate 2. The cover layer 4 made of cermet has an average thickness of approx. 350 μm. Variations in the thickness also arise here from the profiled surface of the substrate 2, which, however, advantageously makes for a better connection between the cover layer 4 and the substrate 2 coated with the intermediate layer 10, by this interlocking effect.

The cover layer 4 as well as the layers 3, 10 lying below it can be restricted to tribologically loaded surfaces, meaning to the friction surfaces of the brake disc.

The matrix metal can be a highly alloyed CrNiMo steel or an NiCrMo alloy. Nickel-based, preferably NiCr alloys or pure matrix metal without ceramic components, are possibilities for the additional intermediate layer 10.

A CrNiMo steel suitable for forming the metallic matrix of the cover layer 4 has the composition Fe 28Cr 16 Ni 4.5 Mo 1.5 Si 1.75 C. Suitable NiCrMo alloys comprise compositions of Ni 20-23Cr<5Fe 8-10Mo 3.15-4.15Nb(+Ta) (Inconel™ 625, Special Metals Corporation, Huntington, W.V., USA), in particular Ni 21.5Cr 2.5Fe 9,0Mo 3.7 (Nb+Ta) is preferably suitable.

Other nickel based alloys, in particular NiCr alloys, are also possibilities as materials to form the intermediate layer 10.

The ceramic component of the cover layer 4 comprises oxide ceramics such as Al₂O₃, TiO₂, ZrO₂ and MgAl₂O₄ (Spinell). These can be chosen individually or in combinations as reinforced ceramic components of the cermet. In this way, the ceramic component alongside Al2O3 as the main component can, for example, have at least one further oxide ceramic as an accessory component, which is chosen from the group comprising TiO₂, ZrO₂, MgAl₂O₄. The proportion of Al₂O₃ in the total ceramic component, whose proportion in cermet material is in the range of 30 to 70% b. w., can thereby make up 60 to 90% b. w. The other oxide ceramics TiO₂, ZrO₂ and/or MgAl₂O₄ are thus correspondingly present, with a proportion of 10 to 40% b. w. of the total ceramic component. The proportion of Al₂O₃ of the total ceramic components is preferably in the range of 75 to 85% b. w., preferably at 80% b.w.

The cover layer 4 applied by thermal spraying, for example, and made of the cermet material has a porosity of under 5% and a microhardness of between 300 HV.03 and 1000 HV.03.

1.-9. (canceled)

10. A brake disc for a motor vehicle, comprising:
a substrate;
a friction surface formed on the substrate; and
a cover layer formed on the friction surface;
wherein the cover layer is harder and thinner than the substrate; and
wherein a color change is included in the cover layer, wherein the color change is formed by a pulsed laser, and wherein the brake disc is identifiable by the color change.

11. The brake disc according to claim 10, wherein the substrate is a grey cast iron.

12. The brake disc according to claim 10, wherein the cover layer has a microhardness of more than 300 HV.03 and/or the cover layer has ceramic and/or the cover layer has a thickness of less than 1000 μm.

13. The brake disc according to claim 10, further comprising a surface layer formed between the substrate and the cover layer wherein the surface layer comprises nitride, carbide, and/or oxide containing layers;
wherein the cover layer consists of a cermet material made of a metallic matrix and a ceramic component distributed in the cermet material and wherein the ceramic component makes up 30 to 70% b. w. of the cermet material.

14. The brake disc according to claim 13, wherein:
the metallic matrix is a high alloy CrNiMo steel which has a composition comprising 28% b. w. chromium, 16% b. w. nickel, 4.5% b. w. molybdenum, 1.5% b. w. silicon, 1.75% b. w. carbon, and the rest iron, or is an NiCrMo alloy which has a composition comprising 20 to 23% b. w. chromium, up to 5% b. w. iron, 8 to 10% b. w. molybdenum, 3.15 to 4.15% niobium and tantalum in total, and the rest nickel.

15. The brake disc according to claim 13, wherein the metallic matrix is an NiCrMo alloy which has a composition comprising 21.5% b. w. chromium, 2.5% b. w. iron, 9.0% b. w. molybdenum, 3.7% b. w. niobium and tantalum in total, and the rest nickel.

16. The brake disc according to claim 13, wherein the ceramic component comprises oxide ceramics which are selected from the group consisting of Al2O3, TiO2, ZrO2 and MgAl2O4 and combinations thereof or wherein the ceramic component comprises Al2O3 and at least one further oxide ceramic selected from the group consisting of TiO2, ZrO2, MgAl2O4, wherein Al2O3 makes up a proportion of 60 to 90% b. w. of total ceramic components.

17. The brake disc according to claim 13, wherein the surface layer, starting from the substrate, has a diffusion layer, a nitride and carbide containing connection layer, and an oxide layer, wherein the diffusion layer has a thickness of 0.1 to 0.8 mm, the connection layer has a thickness of 2 to 30 μm, and the oxide layer has a thickness of 1 to 5 μm.

18. The brake disc according to claim 13, further comprising an intermediate layer disposed between the cover layer and the surface layer, wherein the intermediate layer consists of a nickel based alloy or of the metallic matrix and wherein the intermediate layer has a thickness of 30 to 120 μm.

19. A method for producing a brake disc according to claim 10, comprising the steps of:
producing a brake disc blank;
forming the cover layer; and
introducing of the color change into the cover layer by the pulsed laser, wherein energy of the pulsed laser triggers chemical reactions or fusing processes in the cover layer.

20. The method according to claim 19, further comprising the steps of:
forming a surface layer on the substrate by nitriding, carburizing, or nitrocarburizing in a gas, plasma or salt bath method and/or by anodic or plasmaoxidation oxidizing of the substrate at least on the friction surface;
providing a cermet material made of a metallic matrix and a ceramic component distributed within the cermet material, wherein the ceramic component makes up 30 to 70% b. w. of the cermet material; and
applying the cermet material on the surface layer to form the cover layer.
